(19) United States
(12) Patent Application Publication
(10) Pub. No.: US 2022/0371135 A1
(43) Pub. Date: Nov. 24, 2022

(54) CORE REMOVAL PUNCH AND HOLE FORMING METHOD

(71) Applicant: TOYOTA JIDOSHA KABUSHIKI KAISHA, Toyota-shi (JP)

(72) Inventor: Koichi HAYAMI, Kariya-shi (JP)

(73) Assignee: TOYOTA JIDOSHA KABUSHIKI KAISHA, Toyota-shi (JP)

(21) Appl. No.: 17/658,152

(22) Filed: Apr. 6, 2022

(30) Foreign Application Priority Data
May 19, 2021 (JP) 2021-084543

(51) Int. Cl. B23P 19/02; B21D 28/02

(52) U.S. Cl. CPC B23P 19/02; B21D 28/02

(57) ABSTRACT

The present disclosure provides a core removal punch capable of contributing to simplification of a strip mechanism. A first exemplary aspect is a core removal punch configured to form a hole in a forged product, in which a diameter of a tip part of the core removal punch is smaller than a diameter of a part of the core removal punch other than the tip part thereof, and a step part is formed between the tip part of the core removal punch and the other part thereof.

### CROSS REFERENCE TO RELATED APPLICATIONS

This application is based upon and claims the benefit of priority from Japanese patent application No. 2021-84543, filed on May 19, 2021, the disclosure of which is incorporated herein in its entirety by reference.

### BACKGROUND

The present disclosure relates to a core removal punch and a hole forming method, for example, to a core removal punch and a hole forming method for forming a hole in a forged product.

Since a forged product is formed, for example, by sandwiching a heated material between an upper die and a lower die, a core (e.g., a burr) is formed on an inner peripheral surface of the area of the forged product where a hole is to be formed. In order to remove such a burr, a core removal punch is used as disclosed in Japanese Unexamined Patent Application Publication No. 2003-266138. Note that the part of the core removal punch inserted into the forged product is set to have the same diameter throughout the part thereof.

### SUMMARY

The applicant has however found the following problem. When a hole is formed in the forged product by using the core removal punch disclosed in Japanese Unexamined Patent Application Publication No. 2003-266138, the part of the core removal punch inserted into the forged product is set to have the same diameter throughout the part thereof. Thus, there is a problem that, in a strip process for pulling out the core removal punch in order to eliminate a close contact between the core removal punch and the forged product, the stroke amount of the core removal punch is large.

At this time, when a strip mechanism for pressing the forged product in the strip process is connected to a drive mechanism for stroking the core removal punch, it is necessary to push, by a pushing part including an elastic member such as a spring, a pressing part of the strip mechanism in the direction opposite to a direction in which the core removal punch is pulled out by the stroke amount of the core removal punch. As a result, it is necessary to make the stroke amount of the strip mechanism large. This causes a problem that a size of the strip mechanism increases.

The present disclosure has been made in view of the above-described problem and provides a core removal punch and a hole forming method that are capable of contributing to simplification of a strip mechanism.

A first exemplary aspect is a core removal punch configured to form a hole in a forged product, in which

a diameter of a tip part of the core removal punch is smaller than a diameter of a part of the core removal punch other than the tip part of the core removal punch, and

a step part is formed between the tip part of the core removal punch and the other part of the core removal punch.

Another exemplary aspect is a hole forming method for forming a hole in a forged product by using the above-described core removal punch, the hole forming method including:

placing the forged product on a die;

pressing the forged product by a pressing part of a strip mechanism;

pushing the core removal punch into an area of the forged product where a hole is to be formed, thereby forming the hole; and

pulling out the core removal punch from the hole of the forged product while the pressing part presses the forged product,

in which the pressing part is connected to a drive mechanism configured to move the core removal punch via a pressing mechanism configured to press the pressing part in the strip mechanism to a side of the die.

According to the present disclosure, it is possible to provide a core removal punch and a hole forming method that are capable of contributing to simplification of a strip mechanism.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a cross-sectional view of a core removal punch according to an embodiment as viewed from an X-axis positive side;

FIG. 2 is a diagram of the core removal punch according to the embodiment as viewed from a Z-axis negative side;

FIG. 3 is an enlarged diagram of a part III of FIG. 1;

FIG. 4 is a cross-sectional view showing a state in which a burr present inside an area of a forged product where a hole is to be formed is removed by using the core removal punch according to the embodiment;

FIG. 5 is a cross-sectional view showing a state in which the burr present inside the area of the forged product where a hole is to be formed has been removed by using the core removal punch according to the embodiment;

FIG. 6 is a cross-sectional view showing the forged product in which the hole is formed;

FIG. 7 is a cross-sectional view showing a shape of the hole formed in the forged product in a part VII of FIG. 6; and

FIG. 8 is a cross-sectional view showing a state in which a close contact between the core removal punch according to the embodiment and the forged product is eliminated.

### DESCRIPTION OF EMBODIMENTS

A specific embodiment to which the present disclosure is applied will be described hereinafter in detail with reference to the drawings. However, the present disclosure is not limited to the following embodiment. Further, for the clarification of the description, the following descriptions and the drawings are simplified as appropriate.

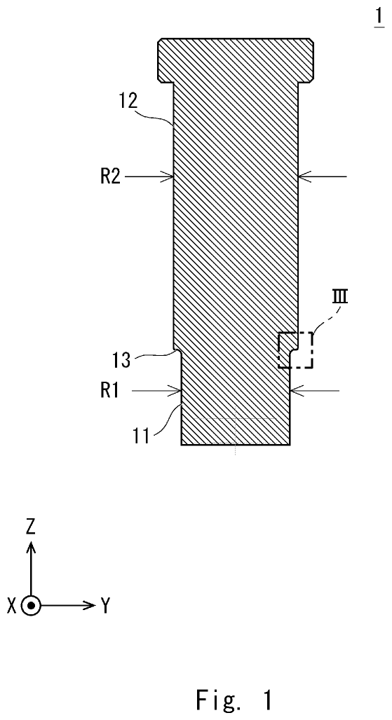

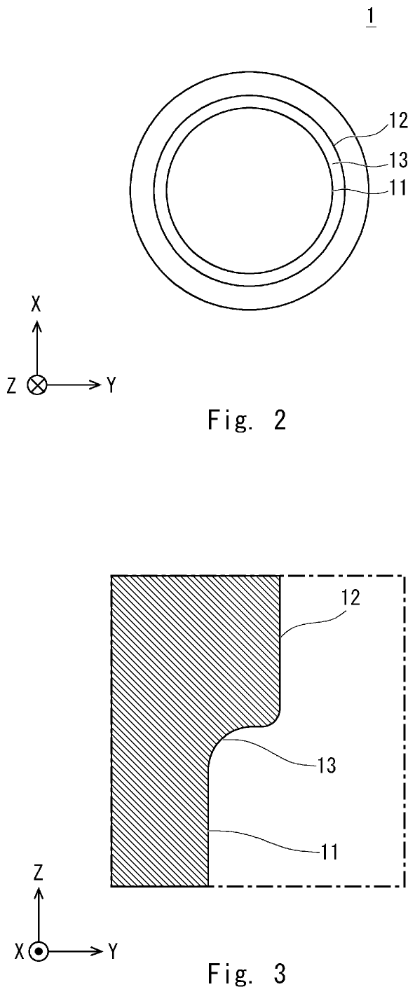

First, a configuration of a core removal punch according to this embodiment will be described. Note that, in the following description, three-dimensional (XYZ) coordinate systems are used for the clarification of the description. FIG. 1 is a cross-sectional view of the core removal punch according to this embodiment as viewed from the X-axis positive side. FIG. 2 is a diagram of the core removal punch according to this embodiment as viewed from the Z-axis negative side. FIG. 3 is an enlarged diagram of a part 111 of FIG. 1. Note that, in FIGS. 1 to 3, the core removal punch is shown in a simplified manner.

As will be described later, a core removal punch 1 is suitably used to remove a burr present inside an area of a forged product where a hole is to be formed. As shown in FIGS. 1 and 2, the core removal punch 1 basically has a columnar shape, and includes a first part 11 and a second part 12. The first part 11 has a first diameter R1 and constitutes an end part of the core removal punch 1 on the Z-axis negative side.

The second part 12 is located on the Z-axis positive side relative to the first part 11. The second part 12 has a second diameter R2 that is larger than the first diameter R1. Note that the second diameter R2 may be substantially equal to a desired diameter (e.g., a product diameter) of a hole formed in a forged product 2.

A central axis of the first part 11 and a central axis of the second part 12 substantially overlap each other. Therefore, as shown in FIGS. 1 to 3, a step part 13 is formed in a boundary part between the first part 11 and the second part 12.

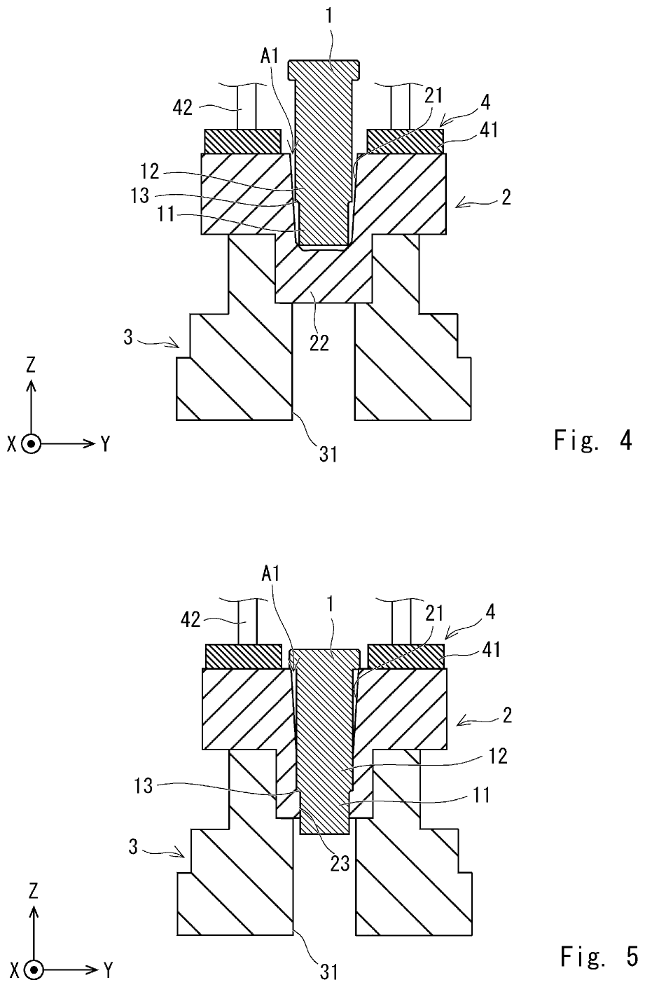

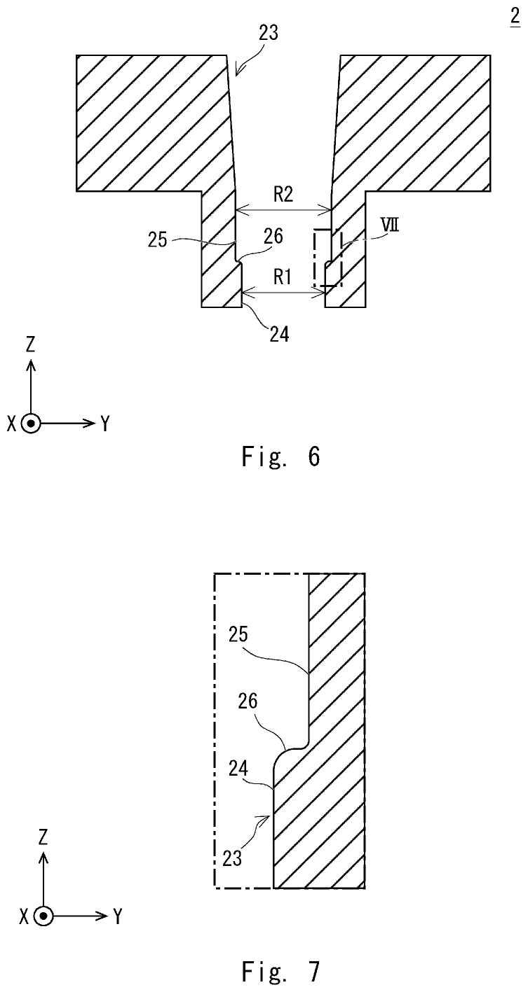

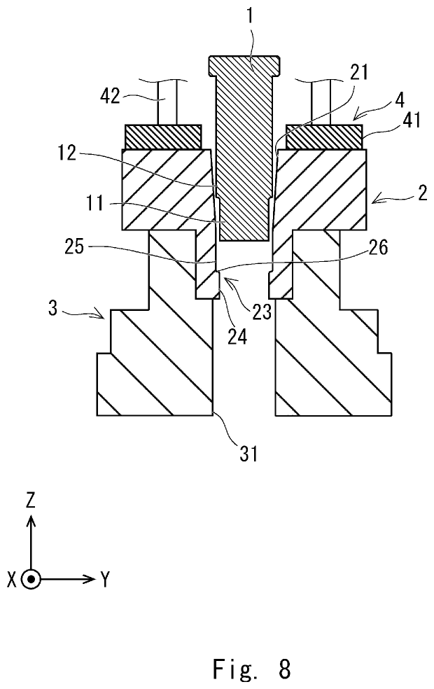

Next, a description will be given of a flow from when a burr present inside an area of the forged product where a hole is to be formed is removed by using the core removal punch 1 according to this embodiment to when the strip process is completed. FIG. 4 is a cross-sectional view showing a state in which a burr present inside an area of a forged product where a hole is to be formed is removed by using the core removal punch according to this embodiment. FIG. 5 is a cross-sectional view showing a state in which the burr present inside the area of the forged product where a hole is to be formed has been removed by using the core removal punch according to this embodiment. FIG. 6 is a cross-sectional view showing the forged product in which the hole is formed. FIG. 7 is a cross-sectional view showing a shape of the hole formed in the forged product in a part VII of FIG. 6. FIG. 8 is a cross-sectional view showing a state in which a close contact between the core removal punch according to this embodiment and the forged product is eliminated.

Here, an end part of the core removal punch 1 on the Z-axis positive side is connected to a drive mechanism that is movable in the Z-axis direction. A die 3 has a shape allowing the forged product 2 to be stably placed on a die, and includes a through hole 31 overlapping in the Z-axis direction with an area A1 of the forged product 2 where a hole is to be formed when the forged product 2 is placed on the die.

A strip mechanism 4 includes a pressing part 41 that presses the forged product 2 and a pushing part 42 including an elastic member such as a spring for pushing the pressing part 41 to the Z-axis negative side, and the pressing part 41 is connected to a drive mechanism that moves the core removal punch 1 in the Z-axis direction via the pushing part 42.

First, as shown in FIG. 4, the forged product 2 is placed on the die 3, and then the first part 11 of the core removal punch 1 is inserted into a recessed part 21 of the area A1 of the forged product 2 where the hole is to be formed, and the core removal punch 1 is pushed to the Z-axis negative side.

At this time, the pressing part 41 of the strip mechanism 4 presses the forged product 2 to make it stable. Here, the recessed part 21 according to this embodiment is formed in a truncated cone shape of which the diameter is reduced toward the Z-axis negative side so that the die for forging can be easily removed when the forged product 2 is formed.

Next, as shown in FIG. 5, the core removal punch 1 is further pushed to the Z-axis negative side, and the end part of the core removal punch 1 on the Z-axis negative side is made to reach the through hole 31 of the die 3. By the above, a burr 22 present inside the area A1 of the forged product 2 where a hole is to be formed is removed by the core removal punch 1, and thereby a hole 23 is formed.

At this time, as shown in FIGS. 6 and 7, a peripheral shape of the first part 11 of the core removal punch 1 and a peripheral shape of the second part 12 of the same are transferred to the peripheral surface of the hole 23. Therefore, the hole 23 includes a first part 24 having the first diameter R1, a second part 25 having the second diameter R2, and a step part 26.

Note that, when the second diameter R2 of the second part 12 of the core removal punch 1 is a desired diameter of the hole 23 formed in the forged product 2, the second part 25 of the hole 23 can also be formed so as to have a desired diameter.

Next, as shown in FIG. 8, the core removal punch 1 is moved to the Z-axis positive side while the pressing part 41 of the strip mechanism 4 presses the forged product 2, and the core removal punch 1 is then pulled out from the hole 23 of the forged product 2.

Note that the second diameter R2 of the second part 25 of the hole 23 is larger than the first diameter R1 of the first part 24 of the hole 23. Thus, when the end part of the second part 12 of the core removal punch 1 on the Z-axis negative side, in other words, the end part of the first part 11 of the core removal punch 1 on the Z-axis positive side, reaches the end part of the second part 25 of the hole 23 on the Z-axis positive side, a close contact between the core removal punch 1 and the forged product 2 is eliminated.

Therefore, when the stroke amount of the core removal punch 1 at the time when the core removal punch 1 is used to remove a burr of a forged product is compared with the stroke amount of a general core removal punch at the time when the general core removal punch is used to remove a burr of a forged product, the stroke amount of the core removal punch 1 can be reduced by the length of the first part 11 of the core removal punch 1 in the Z-axis direction in the strip process for pulling out the core removal punch 1 in order to eliminate a close contact between the core removal punch 1 and the forged product 2.

By the above, since the stroke amount of the pushing part 42 of the strip mechanism 4 can be reduced in the strip process, the strip mechanism 4 can be simplified. After the core removal punch 1 has been pulled out, the hole 23 can be formed so as to have a desired diameter by cutting the first part 24 of the hole 23 using a cutting member to form the diameter of the first part 24 into the second diameter R2.

As described above, the core removal punch 1 according to this embodiment includes the first part 11 having the first diameter R1 and the second part 12 having the second diameter R2 that is larger than the first diameter R1. Further, when the core removal punch 1 is inserted into the area A1 of the forged product 2 where a hole is to be formed and is pushed, the peripheral shape of the first part 11 of the core removal punch 1 and the peripheral shape of the second part 12 of the same are transferred to the forged product 2.

Therefore, when the stroke amount of the core removal punch 1 at the time when the core removal punch 1 is used to remove a burr of a forged product is compared with the stroke amount of a general core removal punch at the time when the general core removal punch is used to remove a burr of a forged product, the stroke amount of the core removal punch 1 can be reduced in the strip process for pulling out the core removal punch 1 in order to eliminate a close contact between the core removal punch 1 and the forged product 2. By the above, since the stroke amount of the pushing part 42 of the strip mechanism 4 can be reduced in the strip process, the strip mechanism 4 can be simplified.

The present disclosure is not limited to the above-described embodiment and may be changed as appropriate without departing from the spirit of the present disclosure.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A core removal punch configured to form a hole in a forged product, wherein
a diameter of a tip part of the core removal punch is smaller than a diameter of a part of the core removal punch other than the tip part of the core removal punch, and
a step part is formed between the tip part of the core removal punch and the other part of the core removal punch.

2. A hole forming method for forming a hole in a forged product by using the core removal punch according to claim 1, the hole forming method comprising:
placing the forged product on a die;
pressing the forged product by a pressing part of a strip mechanism;
pushing the core removal punch into an area of the forged product where a hole is to be formed, thereby forming the hole; and
pulling out the core removal punch from the hole of the forged product while the pressing part presses the forged product,
wherein the pressing part is connected to a drive mechanism configured to move the core removal punch via a pressing mechanism configured to press the pressing part in the strip mechanism to a side of the die.
